(19) United States
(12) Patent Application Publication
(10) Pub. No.: US 2005/0145492 A1
(43) Pub. Date: Jul. 7, 2005

(54) Solid electrolyte sensor for determining the concentration of a gas component in a gas mixture

(76) Inventors: Rainer Strohmaier, Stuttgart (DE); Carsten Springhorn, Stuttgart (DE); Ruediger Deibert, Esslingen (DE); Lothar Diehl, Gerlingen (DE)

Correspondence Address: KENYON & KENYON, ONE BROADWAY, NEW YORK, NY, 10004, US

(21) Appl. No.: 10/495,647

(22) PCT Filed: Oct. 4, 2002
(86) PCT No.: PCT/DE02/03774

(30) Foreign Application Priority Data
Nov. 24, 2001 (DE) 101 57 733.8

(51) Int. Cl. G01N 27/26

(52) U.S. Cl. 204/424; 204/426

(57) ABSTRACT

A sensor for determining the concentration of a gas component in a gas mixture is provided, including at least one pump cell having an outer pump electrode which is exposed to the gas mixture and an inner pump electrode located in a measuring chamber, and further including a Nernst cell having a Nernst electrode located in the measuring chamber and a reference electrode located in a reference gas channel. The pump cell and the Nernst are formed in a composite structure of stacked solid electrolyte layers, which structure has an upper layer containing the pump electrodes, a middle layer containing the measuring chamber and the reference gas channel, as well as a lower layer containing a heating element and two supply leads. To suppress noise in the output signal of the sensor, the leads of the Nernst cell are disposed in one plane, in parallel side-by-side relationship, and symmetrically to at least one of the two supply leads of the heating element.

### FIELD OF THE INVENTION

The present invention relates to a sensor for determining the concentration of a gas component in a gas mixture, in particular, a planar broadband lambda sensor for determining the oxygen concentration in the exhaust gas of an internal combustion engine.

### BACKGROUND INFORMATION

In a known sensor of this type described in published German patent document DE 199 41 051, for example, the leads of the concentration or Nernst cell run on both sides of the reference gas channel in the middle layer of the multi-layer composite structure, and are therefore located above the supply leads of the heating element. The heating element is operated in cycles in order to control the heating power. For this purpose, an electric semiconductor switch, which is referred to as “low-side switch”, is provided on the low-voltage side of the heating element, and is controlled to open in accordance with the desired heating power output so that the heating element is energized intermittently. The switching of the heating element causes noise in the output signal of the sensor due to capacitive, inductive, and resistive coupling into the Nernst cell. The cross-coupling interference levels are particularly high because the Nernst cell is of high resistance, the distance between the Nernst cell and the heating element is very small, the dielectric constant εᵣ of the layers and of the heating element insulation strongly increases as the region of the leads is heated, and because the leads of the Nernst cell run along the leads of the heating elements.

### SUMMARY

The sensor according to the present invention has the advantage that the above-mentioned noise in the output signal of the sensor is substantially suppressed. In an embodiment of the sensor according to the present invention, this is achieved in that, due to the arrangement of the two leads of the Nernst cell, i.e., the lead to the Nernst electrode on the one hand and, on the other hand, the lead to the reference electrode, the interference coupled into the two leads is substantially the same that is compensated for with respect to the Nernst voltage at the connecting contacts. In an embodiment of the sensor according to the present invention, this is achieved in that, due to the shielding of the lead to the reference electrode, which is accomplished by the lead to the Nernst electrode, substantially no interference is coupled into the reference electrode.

In accordance with the present invention, the Nernst cell can have a high resistance, and no consideration needs to be given to the heating of the region of the leads to the Nernst cell. There is no need to build up an equipotential layer above the heating element in a complex manner. The inventive routing of the leads, including the insulation which may be provided to cover the leads, can be made efficiently and without problems.

### BRIEF DESCRIPTION OF THE DRAWINGS

FIG. 1 is a sectional view taken along line I-I in FIG. 2 showing a planar broadband lambda sensor according to the present invention for determining the oxygen concentration in the exhaust gas of an internal combustion engine.

FIG. 2 is a sectional view taken along line II-II in FIG. 1.

FIG. 3 is a sectional view taken along line III-III in FIG. 2.

FIG. 4 is a sectional view taken along line IV-IV in FIG. 2.

FIG. 5 shows a second exemplary embodiment of the lambda sensor according to the present invention.

FIG. 6 is a sectional view taken along line VI-VI in FIG. 5.

FIG. 7 shows a lambda sensor according to a third exemplary embodiment according to the present invention.

FIG. 8 is a sectional view taken along line VIII-VIII in FIG. 7.

FIG. 9 is a sectional view taken along line IX-IX in FIG. 10 showing a fourth exemplary embodiment of a planar broadband lambda sensor according to the present invention for determining the oxygen concentration in the exhaust gas of an internal combustion engine.

FIG. 10 is a sectional view taken along line X-X in FIG. 9.

FIG. 11 is a sectional view taken along line XI-XI in FIG. 10.

FIG. 12 is a sectional view taken along line XII-XII in FIG. 10.

FIG. 13 shows a lambda sensor according to a fifth exemplary embodiment according to the present invention.

FIG. 14 is a sectional view taken along line XIV-XIV in FIG. 13.

FIG. 15 shows a lambda sensor according to a sixth exemplary embodiment according to the present invention.

FIG. 16 is a sectional view taken along line XVI-XVI in FIG. 15.

FIG. 17 shows a lambda sensor according to a seventh exemplary embodiment according to the present invention.

FIG. 18 is a sectional view taken along line XVIII-XVIII in FIG. 17.

FIG. 19 is a sectional view taken along line IXX-IXX in FIG. 17.

### DETAILED DESCRIPTION

In all exemplary embodiments described herein, the planar broadband lambda sensor for determining the oxygen concentration in the exhaust gas of an internal combustion engine has a pump cell 11 including an outer pump electrode 12 and an inner pump electrode 13, as well as a concentration cell, or so-called “Nernst cell” 14 including a Nernst electrode 15 and a reference electrode 16. Pump cell 11 and Nernst cell 14 are formed in a composite structure of stacked solid electrolyte layers, of which an upper layer 17 supports pump electrodes 12, 13 on opposite surfaces, a middle layer 18 contains a measuring chamber 21 and a reference gas channel 22 filled with porous zirconium dioxide (ZrO₂) or aluminum oxide (Al₂O₃), and a lower layer 20 supports a heating element 24 which is formed by a meandering conductor track and is embedded in an electrical insulation 23 of aluminum oxide (Al₂O₃). A further intermediate layer 19 is sandwiched between middle layer 18 and lower layer 20. Upper layer 17, intermediate layer 19, and lower layer 20 are made as ceramic films, while middle layer 18 is produced by screen printing a paste-like ceramic material, for example, on upper layer 17. The material used as the ceramic component of the paste-like material may be the same solid electrolyte material of which the films forming upper layer 17, intermediate layer 19, and lower layer 20 are made. Upper layer 17 is hereinafter referred to as “pump film 17”, intermediate layer 19 as “intermediate film 19”, and lower layer 20 as “heater film 20”. Middle layer 18 is denoted as “reference channel layer 18”. The integrated planar multi-layer composite structure is made by laminating together the ceramic films on which reference channel layer 18 is printed, and subsequently sintering the laminar structure.

The solid electrolyte material used is, for example, a mixed oxide of zirconium dioxide (ZrO₂) and yttrium oxide (Y₂O₃), which is also referred to as Y₂O₃-stabilized or partially stabilized ZrO₂.

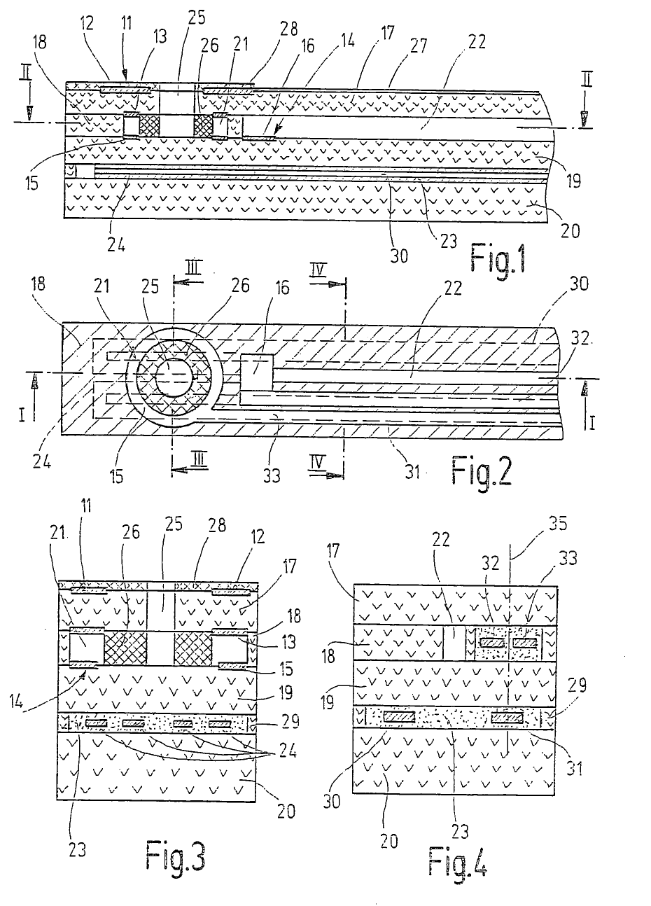

As can be seen in FIGS. 1 and 2, reference gas channel 22 and measuring chamber 21 in reference channel layer 18 are separated from each other by a partition, which is an integral part of reference channel layer 18. Measuring chamber 21 has an annular shape and is in communication with the exhaust gas via an opening 25. Opening 25 is made in pump film 17 in a vertical direction. Measuring chamber 21 is covered by a porous diffusion barrier 26 with respect to opening 25. Located in measuring chamber 21 are, on the one hand, inner pump electrode 13 of pump cell 11 and, on the other hand, Nernst electrode 15 of Nernst cell 14. In the exemplary embodiment, the electrodes 13, 15 mentioned are annular in shape and spaced opposite each other. Outer pump electrode 12, which is applied to the outside of pump film 17 in a circle around opening 25, is covered by a porous protective layer 28 and contacted via a lead 27 which is applied to the surface of pump film 17.

Heating element 24, which is designed as a resistance heater, is embedded in electrical insulation 23 and supported by heater film 20. Insulation 23 is enclosed by a crosspiece of solid electrolyte 29 which is printed on heater film 20 or intermediate film 19. Heating element 24, which is arranged in a meandering pattern, is energized with an electric current in cycles via supply leads 30, 31, which are designed as wide, flat conductor tracks and are also embedded in insulation 23.

Nernst cell 14 has a lead 32 contacting reference electrode 16, and a lead 33 contacting Nernst electrode 15. Inner pump electrode 13 of pump cell 11 is contacted via lead 33 so that Nernst electrode 15 and inner pump electrode 13 are at the same potential. In all exemplary embodiments of the lambda sensor shown in the figures, the leads 32, 33 to Nernst cell 14 run in middle layer 18, that is, in reference channel layer 18. The various exemplary embodiments of the lambda sensor described herein differ only with respect to the specific routing of leads 32, 33 within reference channel layer 18 relative to supply leads 30, 31 of heating element 24.

In the exemplary embodiments of the lambda sensor shown in FIGS. 1-8, the leads 32, 33 of Nernst cell 14 are disposed in a plane parallel to the layers, in parallel side-by-side relationship and symmetrically to at least one of the two supply leads 30, 31 of heating element 24. Both leads 32, 33 are designed as wide, flat conductor tracks and embedded in an insulation 34 of aluminum oxide (Al₂O₃). Lead 32 to reference electrode 16 is always closer to reference gas channel 22. Alternatively, lead 32 can also run in reference channel 22 itself.

In the lambda sensor according to the exemplary embodiment shown in FIGS. 1-4, on the one hand, and the embodiment shown in FIGS. 5 and 6, on the other hand, the leads 32, 33 of Nernst cell 14 run mirror-symmetrically to a median plane 35 of supply lead 31 of heating element 24 and, due to their arrangement in reference channel layer 18, above supply lead 31; the median plane extends perpendicular to layers 17-20. As an example, supply lead 31 is the unswitched supply lead, that is, the supply lead to which the low-side switch, which is operated in cycles, is not connected. In the exemplary embodiment shown in FIGS. 1-4, leads 32, 33 cover supply lead 31, as can be seen from FIG. 4, while in the exemplary embodiment shown in FIGS. 5 and 6, leads 32, 33 do not cover supply lead 31, but are located on both sides of supply lead 31 as narrow conductor tracks, as can be seen from FIG. 6.

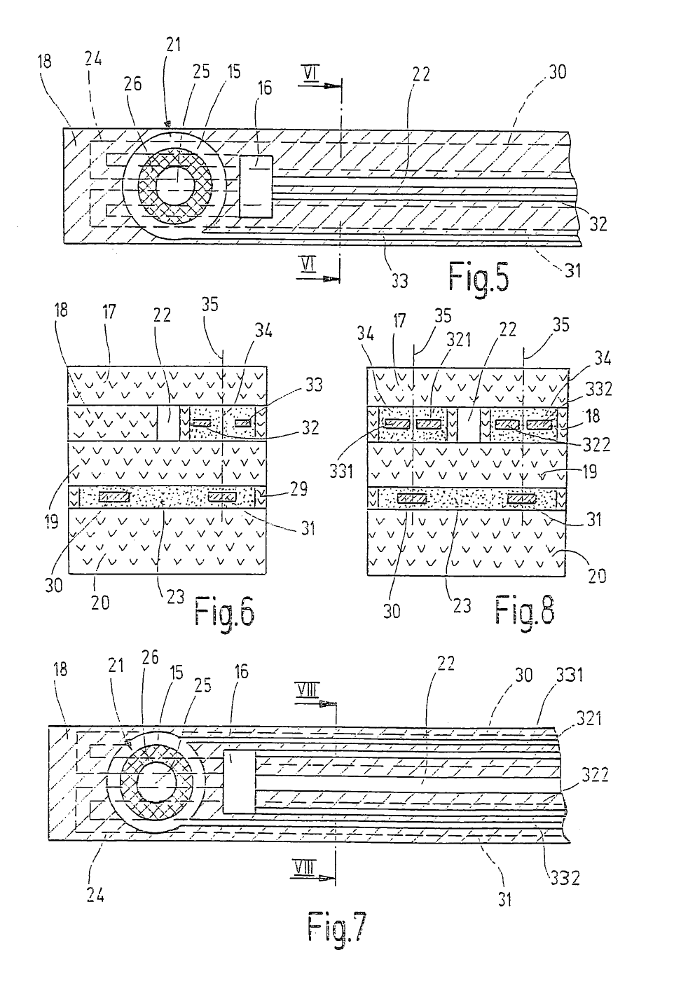

In the exemplary embodiment of the lambda sensor shown in FIGS. 7 and 8, each of the leads 32, 33 to the electrodes 16, 15 of Nernst cell 14 is divided into two parallel lead paths 321, 322 and 331, 332, respectively, and each pair of lead paths 321, 322 and 331, 332 is associated with a supply lead 30 or 31, respectively. The pair of lead paths associated with supply lead 30 is composed of the lead path 321 to reference electrode 16 and the lead path 331 to Nernst electrode 15, and the pair associated with supply lead 31 is composed of the lead path 322 to reference electrode 16 and the lead path 332 to Nernst electrode 15. Each pair of lead paths 321, 331 and 322, 332 is, in turn, aligned symmetrically to median plane 35 of the associated supply lead 30 or 31, respectively, which are designed as wide conductor tracks. Lead paths 321 and 322 to reference electrode 16 extend directly along reference channel 22, and are therefore located between the reference channel and the lead paths 321 and 322 to Nernst electrode 15. In the exemplary embodiment shown, each pair of lead paths 322, 332 and 321, 331 covers its associated supply lead 30 or 31, respectively. However, the pairs of lead paths 322, 332 and 321, 331 can also be arranged as in FIG. 6, so that they are located on both sides of the associated supply leads as narrow conductor tracks.

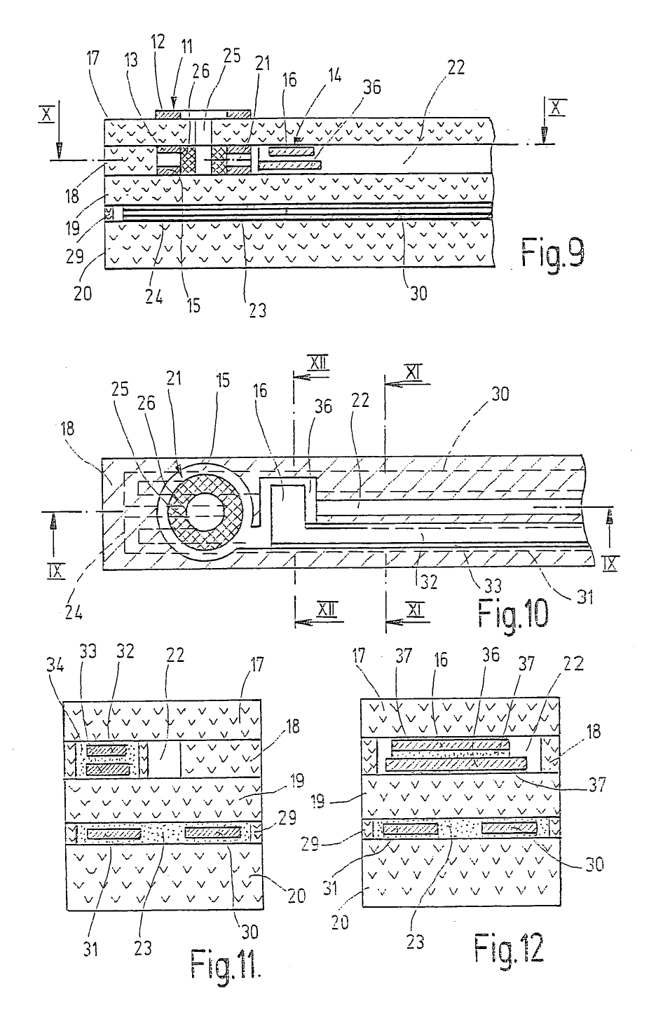

In the exemplary embodiments of the lambda sensor shown in FIGS. 9-19, the leads 32, 33 of Nernst cell 14 are arranged within reference channel layer 18 in such a manner that the lead 33 to Nernst electrode 15 forms a shield for the lead 32 to reference electrode 16 with respect to supply leads 30, 31 of heating element 24. Here too, the leads 32, 33 of Nernst cell 14, as well as the supply leads 30, 31 of heating element 24, are designed as wide, flat conductor tracks. Again, lead 33 to Nernst electrode 15 is, at the same time, the lead to inner pump electrode 13 of pump cell 11.

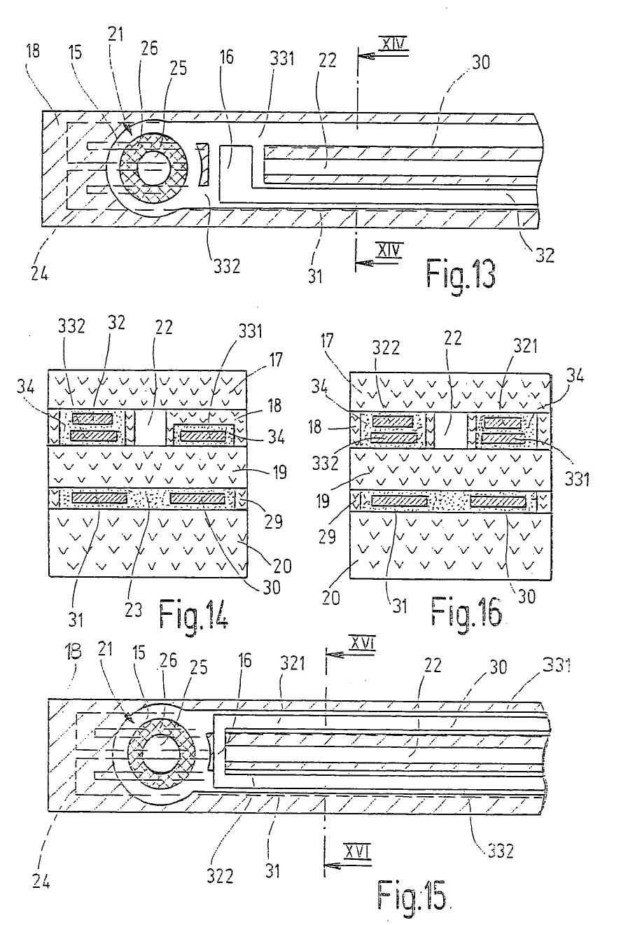

In the exemplary embodiment shown in FIGS. 9-12, the leads 32, 33 of Nernst cell 14 extend parallel, one above the other, in such a manner that the lead 33 to Nernst electrode 15 is located between the lead 32 to reference electrode 16 and the supply lead 31 of heating element 24. In addition, an additional area 36 can be formed at the lead 33 to Nernst electrode 15, the additional area covering reference electrode 16. In this manner, reference electrode 16 is itself shielded from supply line 31 of heating element 24. As can be seen from the sectional view of FIG. 12, an insulation 37 of aluminum oxide (Al₂O₃) is arranged between additional area 36 and reference electrode 16, as well as below additional area 36 and above reference electrode 16.

In the exemplary embodiment of the lambda sensor according to FIGS. 13 and 14, the lead 33 to Nernst electrode 15 is divided into two parallel lead paths 331, 332, of which in each case one runs above a supply lead 30 or 31 of heating element 24. As can be seen from the sectional view in FIG. 14, the lead path 332 to Nernst electrode 15 is located between the lead 32 to reference electrode 16 and supply lead 31 of heating element 24, while the lead path 331 to Nernst electrode 15 extends parallel to supply line 30 within reference channel layer 18. Both lead path 332 and lead path 331 are aligned symmetrically to the associated supply line 31 or 30, respectively.

In the exemplary embodiment of the lambda sensor shown in FIGS. 15 and 16, the lead 32 to reference electrode 16 is also divided into two lead paths 321 and 322. The lead paths 321, 322 to reference electrode 16 and the lead paths 331, 332 to Nernst electrode 15 are arranged symmetrically, and each pair of lead paths to reference electrode 16 and lead paths to Nernst electrode 15 is associated with a supply lead, respectively. As can be seen from FIG. 16, the lead path 332 to Nernst electrode 15 is arranged between the lead path 322 to reference electrode 16 and supply lead 31 of heating element 24, and the lead path 331 to Nernst electrode 15 is disposed between the lead path 321 to reference electrode 16 and supply lead 30 of heating element 24.

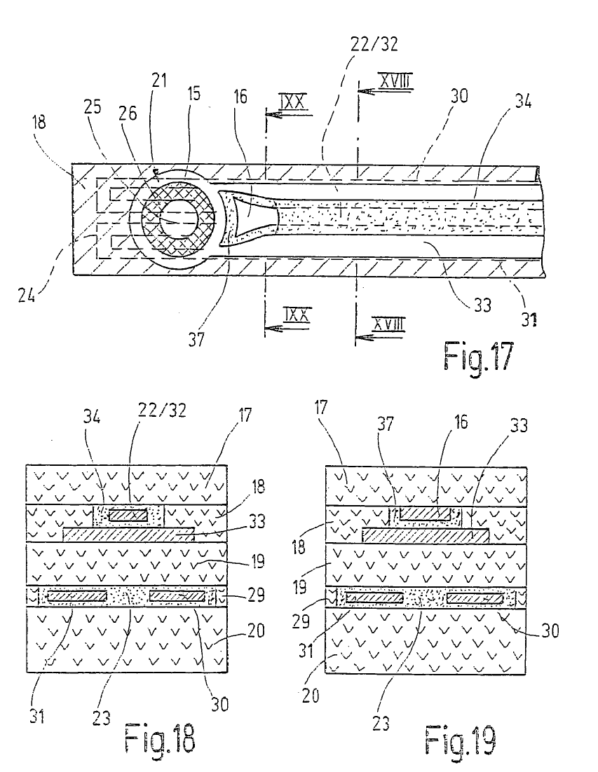

In the exemplary embodiment of the lambda sensor shown in FIGS. 17-19, reference gas channel 22 is formed by the lead 32 of reference electrode 16 in that the lead 32 is made of electrode paste which is sintered to a porous structure. Lead 32 is embedded in an electrical insulation 34 of Al₂O₃, that is, surrounded on all sides by insulation 34 (FIG. 18). Lead 32 is designed to be considerably narrower than lead 33 of Nernst electrode 15 and is arranged centrally thereto, the lead 33 substantially covering the two supply leads 30, 31 of heating element 24. Reference electrode 16 itself, except for its surface adjacent to upper layer 17, i.e., pump film 17, is surrounded by an insulation 37 of the same material as insulation 34 so that the reference electrode is electrically isolated from the section of lead 33 of Nernst electrode 15 that runs below (FIG. 19). The lead 33 of Nernst electrode 15 does not have any insulation, and is located directly on the solid electrolyte (FIGS. 18 and 19).

In a modification of the planar broadband lambda sensors described above, intermediate layer 19 in the multi-layer composite structure may be omitted, resulting in a smaller thickness of the sensor, or allowing the upper and lower layers 17, 20 to be made on the substrate having the same thickness.

1-22. (canceled)

23. A sensor for determining a concentration of a gas component in a gas mixture, comprising:
at least one pump cell having an outer pump electrode exposed to the gas mixture and an inner pump electrode located in a measuring chamber; and
at least one Nernst cell having a Nernst electrode located in the measuring chamber and a reference electrode located in a reference gas channel that is separated from the measuring chamber;
wherein the pump cell and the Nernst cell are formed in a composite structure of stacked solid electrolyte layers, the stacked solid electrolyte layers including:
an upper layer that supports the outer and inner pump electrodes on opposite surfaces;
a middle layer that contains the measuring chamber, the reference gas channel, and electrical leads leading to the inner pump electrode, to the Nernst electrode, and to the reference electrode; and
a lower layer that contains a heating element, the heating element and two electrical supply leads being embedded in an electrical insulation positioned within the lower layer;
wherein the electrical leads leading to the Nernst electrode and the reference electrode of the Nernst cell extend in a plane parallel to the stacked solid electrolyte layers, in parallel side-by-side relationship and symmetrically to at least one of the two supply leads of the heating element.

24. The sensor according to claim 23, wherein the electrical leads leading to the Nernst electrode and to the reference electrode of the Nernst cell, and the two supply leads of the heating element, are wide, flat conductor tracks.

25. The sensor according to claim 24, wherein the electrical leads leading to the Nernst electrode and to the reference electrode of the Nernst cell extend symmetrically to a median plane of at least one of the two supply leads of the heating element, wherein the median plane extends perpendicular to the stacked solid electrolyte layers.

26. The sensor according to claim 25, wherein the electrical leads leading to the Nernst electrode and to the reference electrode of the Nernst cell are located above, and at least partially cover, the at least one of the two supply leads of the heating element.

27. The sensor according to claim 25, wherein the electrical leads leading to the Nernst electrode and to the reference electrode of the Nernst cell are located above both lateral sides the at least one of the two supply leads of the heating element.

28. The sensor according to claim 23, wherein the electrical lead leading to the reference electrode is one of closer to the reference gas channel than the electrical lead leading to the Nernst electrode, or extends in the reference gas channel.

29. The sensor according to claim 23, wherein, in order to control a heating current, the heating element is cyclically switched on and off via one of the two electrical supply leads of the heating element, and an un-switched electrical supply lead of the heating element is the one of the two supply leads that is positioned symmetrically with respect to the electrical leads that extend to the reference electrode and the Nernst electrode of the Nernst cell.

30. The sensor according to claim 23, wherein each of the leads leading to the Nernst electrode and to the reference electrode of the Nernst cell is divided into two parallel lead paths, each pair of lead paths including a lead path to the Nernst electrode and a lead path to the reference electrode, each pair of lead paths being associated with one of the two electrical supply leads of the heating element, and wherein, in each pair of lead paths, the lead path to the reference electrode is closer to the reference gas channel.

31. A sensor for determining a concentration of a gas component in a gas mixture, comprising:
at least one pump cell having an outer pump electrode exposed to the gas mixture and an inner pump electrode located in a measuring chamber; and
at least one Nernst cell having a Nernst electrode located in the measuring chamber and a reference electrode located in a reference gas channel that is separated from the measuring chamber;
wherein the pump cell and the Nernst cell are formed in a composite structure of stacked solid electrolyte layers, the stacked solid electrolyte layers including:
an upper layer that supports the outer and inner pump electrodes on opposite surfaces;
a middle layer that contains the measuring chamber, the reference gas channel, and electrical leads leading to the inner pump electrode, to the Nernst electrode, and to the reference electrode; and
a lower layer that contains a heating element, the heating element and two electrical supply leads being embedded in an electrical insulation positioned within the lower layer;
wherein the electrical lead leading to the Nernst electrode forms a shield for the electrical lead leading to the reference electrode with respect to the two electrical supply leads of the heating element.

32. The sensor according to claim 31, wherein the electrical leads leading to the Nernst electrode and to the reference electrode of the Nernst cell, and the two electrical supply leads of the heating element, are wide, flat conductor tracks.

33. The sensor according to claim 31, wherein the electrical leads leading to the Nernst electrode and to the reference electrode of the Nernst cell extend in parallel, one above the other, and wherein the electrical lead leading to the Nernst electrode is located between the electrical lead leading to the reference electrode and at least one of the electrical supply leads of the heating element.

34. The sensor according to claim 31, wherein the electrical lead leading to the Nernst electrode has an area which covers the reference electrode.

35. The sensor according to claim 31, wherein the electrical lead leading to the Nernst electrode is divided into two parallel lead paths, each of the two parallel lead paths extending above and along at least one of the electrical supply leads of the heating element.

36. The sensor according to claim 31, wherein the electrical lead leading to the Nernst electrode and the electrical lead leading to the reference electrode are each divided into a pair of parallel lead paths, and wherein for each pair of parallel lead paths, one lead path leading to the Nernst electrode is located between one of the two electrical supply leads of the heating element and a lead path leading to the reference electrode.

37. The sensor according to claim 23, wherein the electrical leads leading to the Nernst electrode and the reference electrode of the Nernst cell are embedded in an electrical insulation.

38. The sensor according to claim 31, wherein the electrical lead leading to the reference electrode is made of porously sintered electrode paste and defines at least a portion of the reference gas channel.

39. The sensor according to claim 38, wherein the electrical lead leading to the Nernst electrode is substantially wider than the electrical lead leading to the reference electrode, and wherein the electrical lead leading to the reference electrode is arranged centrally with respect to the electrical lead leading to the Nernst electrode.

40. The sensor according to claim 38, wherein the electrical lead leading to the reference electrode is embedded in an electrical insulation.

41. The sensor according to claim 38, wherein the reference electrode is surrounded by an electrical insulation, except for a surface portion of the reference electrode adjacent to the upper layer of the stacked solid electrolyte layers.

42. The sensor according to claim 23, wherein the Nernst electrode of the Nernst cell and the inner pump electrode of the pump cell are at substantially the same potential, and wherein the electrical lead leading to the Nernst electrode forms the electrical lead leading to the inner pump electrode.

43. The sensor according to claim 37, wherein the electrical insulation is made of aluminum oxide (Al₂O₃).

44. The sensor according to claims 23, wherein the stacked solid electrolyte layers are made of a mixed oxide of zirconium dioxide (ZrO₂) and yttrium oxide (Y₂O₃).
